(19) United States
(12) Patent Application Publication
(10) Pub. No.: US 2011/0037715 A1
(43) Pub. Date: Feb. 17, 2011

(54) TOUCH PANEL CORRECTING APPARATUS AND THE METHOD THEREFOR

(75) Inventors: Sheng-Chun Chueh, HsinTien (TW); Hung-Yi Lin, HsinTien (TW); Por-Chin Hsu, HsinTien (TW)

Correspondence Address: ROGER H. CHU, 19499 ERIC DRIVE, SARATOGA, CA, 95070, US

(73) Assignee: IDEACOM TECHNOLOGY CORPORATION, HsinTien (TW)

(21) Appl. No.: 12/851,812

(22) Filed: Aug. 6, 2010

(30) Foreign Application Priority Data
Aug. 14, 2009 (TW) 098127354

(51) Int. Cl. G06F 3/041

(52) U.S. Cl. 345/173

(57) ABSTRACT

The invention relates to a touch panel correcting apparatus includes a control module, a processing module, a detecting module, a judging module and a correcting module. The control module is used for generating a controlling signal. The processing module is used for executing a pointing action under a first predetermined manner after receiving the controlling signal. The detecting module is used for detecting the touch panel according to the pointing action under a second predetermined manner and generating at least one detecting result. The judging module is used for executing a predetermined operation according to the at least one detecting result and a predetermined information and generating at least one correcting value. The correcting module is used for correcting the touch panel according to the at least one correcting value.

### BACKGROUND OF THE INVENTION

1. Field of the Invention

The invention is related to a touch panel correcting apparatus and a method, in specific to a touch panel correcting apparatus and a method for correcting the position of displayed image on a touch panel.

2. Description of the Prior Art

Various kinds of touch sensing technology are used in many different electronic products in recently years for the progress in technology and the convenience in use. Touch pad is implemented in various kinds of electronic products because it has advantages in small size, less cost, low power assumption and durable life period.

However, the operation of the touch panel is to provide items on the screen of the touch panel for pointing out the desired items by the user. If the positions of the items on the screen are not match to the setting positions of the controller of the touch panel, the touch panel has the disadvantage that when user touches the items displayed on the screen of the touch panel, the controller cannot determine which item has touched by the user and also cannot execute the corresponding action accurately. Therefore, how to correct the touched point of the touch panel is one of the most important factors of using the touch panel accurately.

Please referring to FIG. 1A, FIG. 1A is a schematic diagram of a resistive touch panel in the prior art. As shown in FIG. 1A, the resistive touch panel 10 detects the touched point executed by the user by detecting the terminal X+, X−, Y+, Y− of those two conductive layers 12, 14 respectively. This kind of resistive touch panel 10 detects the touched point by detecting the conductive layers 12, 14 on the same plane. Therefore, the resistive touch panel 10 cannot detect the multi touched points executed by the user which is inconvenient to the user for using the touch panel 10.

Please referring to FIG. 1B, FIG. 1B is a schematic diagram of another resistive touch panel in the prior art. As shown in FIG. 1B, a new design resistive touch panel is developed, the new design resistive touch panel 11 is designed by the partition conception that divided those conductive layers 13, 15 into a plurality of detecting zones (X1˜X8, Y1˜Y8) which are divided into a plurality of X axis detecting zones (X1˜X8) of the upper conductive layer 13 and a plurality of Y axis detecting zones (Y1˜Y8) of the lower conductive layer 15. Because of those detecting zones (X1˜X8, Y1˜Y8) are independent to each other, user can get the actually touched point according to a X axis touched point and a Y axis touched point generated by detecting each X axis detecting zone (X1˜X8) and each Y axis detecting zone (Y1˜Y8) correspondingly.

Due to each X axis detecting zone (X1˜X8) and each Y axis detecting zone (Y1˜Y8) of the resistive touch panel 11 are independent to each other respectively, so that may exist the disadvantage caused by the drifting of manufacturing process or the resistance inaccuracy caused by different lengths of the conductive lines between the detecting circuit of the touch panel. Furthermore, the resistance inaccuracy causes the disadvantage of inaccuracy detecting the touched point, for example: When user touches two X axis detecting zones (X1˜X8) located on the same horizontal line, the touch panel detecting circuit may detect those two touched points not located on the same horizontal line because the resistance inaccuracy exists between two X axis detecting zones (X1˜X8). At this condition, it has problem when user uses the touch panel 11 that the touch panel detecting circuit may detect incorrect touched points.

Therefore, how to improve the disadvantage of inaccurately detecting the touched point on the touch panel touched by the user in the prior art and to provide a touch panel correcting apparatus and method is an important topic for the manufacturer to produce the touch panel.

### SUMMARY OF THE INVENTION

It is therefore a primary objective of the present invention to provide a touch panel correcting apparatus and a method for correcting the process shift of the touch panel and further enhancing the accuracy of the touch panel.

One embodiment of the present invention provides a touch panel correcting apparatus comprising a control module, a processing module, a detecting module, a judging module and a correcting module. The control module is used for generating a controlling signal. The processing module coupled to the control module and a touch panel is used for executing a pointing action under a first predetermined manner after receiving the controlling signal. The detecting module coupled to the control module, the processing module and the touch panel is used for detecting the touch panel according to the pointing action under a second predetermined manner and generating at least one detecting result. The judging module coupled to the processing module and the detecting module for executing a predetermined operation according to the at least one detecting result and a predetermined information and generating at least one correcting value. The correcting module coupled to the judging module and the touch panel is used for correcting the touch panel according to the at least one correcting value.

Another embodiment of the present invention provides a touch panel correcting method comprising the following steps: generating at least one controlling signal; executing a pointing action under a first predetermined manner after receiving the controlling signal; detecting the touch panel according to the pointing action under a second predetermined manner and generating at least one detecting result; executing a predetermined operation according to the at least one detecting result and a predetermined information and generating at least one correcting value; and then correcting the touch panel according to the at least one correcting value.

These and other objectives of the present invention will no doubt become obvious for those with ordinary skill in the art after reading the following detailed description of the preferred embodiment that is illustrated in the various figures and drawings.

### BRIEF DESCRIPTION OF THE DRAWINGS

FIG. 1A is a schematic diagram of a resistive touch panel in the prior art.

FIG. 1B is a schematic diagram of another resistive touch panel in the prior art.

FIG. 2 is a schematic diagram of the touch panel correcting apparatus according to the present invention.

FIG. 3 is a schematic diagram of an embodiment of the image correcting process of the touch panel correcting apparatus according to the present invention.

FIG. 4 is a schematic diagram of an embodiment of the plurality of detecting sections of the touch panel correcting apparatus according to the present invention.

FIG. 5 is a flowchart diagram of an embodiment of the touch panel correcting method according to the present invention.

### DETAILED DESCRIPTION

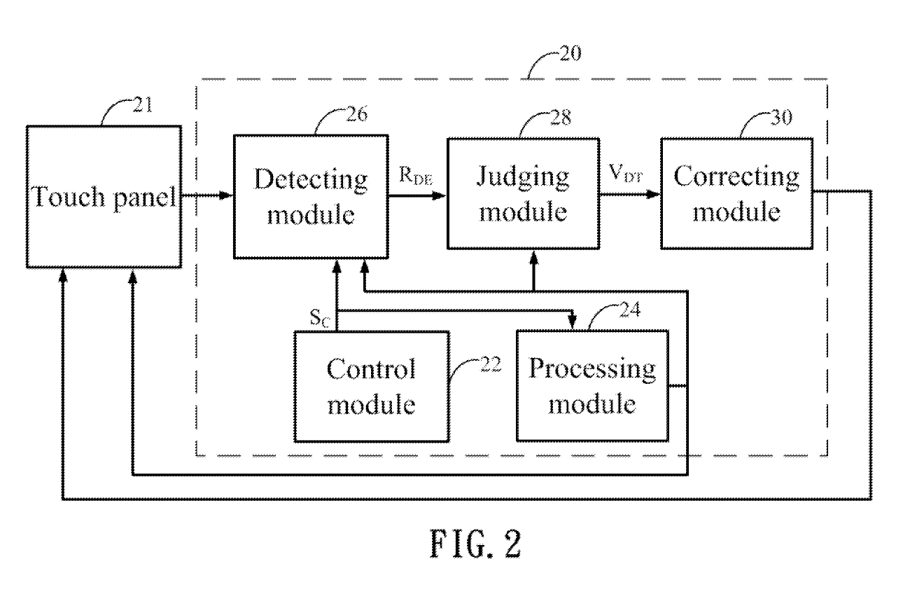

Please referring to FIG. 2, FIG. 2 is a schematic diagram of the touch panel correcting apparatus according to the present invention. As shown in FIG. 2, the present invention is a touch panel 21 correcting apparatus 20 used for correcting original image displayed by a touch panel 21. The touch panel 21 correcting apparatus 20 comprises a control module 22, a processing module 24, a detecting module 26, a judging module 28 and a correcting module 30. The control module 22 is used for a controlling signal S_{C}. The processing module 24 coupled to the control module 22 and the touch panel 21 is used for executing a pointing action under a first predetermined manner after receiving the controlling signal S_{C}. The detecting module 26 coupled to the control 22, the processing module 24 and the touch panel 21 is used for detecting the touch panel 21 according to the pointing action under a second predetermined manner and generating at least one detecting result R_{DE}. The judging module 28 coupled to the processing module 24 and the detecting module 26 is used for executing a predetermined operation according to the at least one detecting result R_{DE} and a predetermined information and then generating at least one correcting value V_{DT} correspondingly. The correcting module 30 coupled to the judging module 28 and the touch panel 21 is used for correcting the touch panel 21 according to the at least one correcting value V_{DT}.

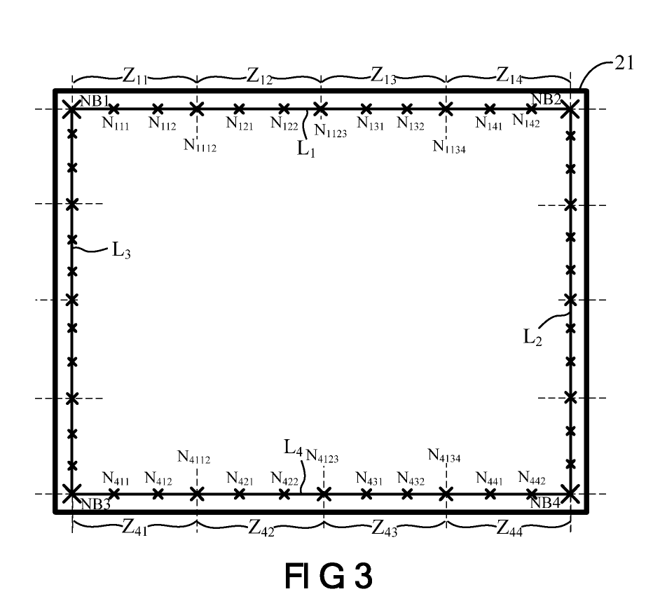

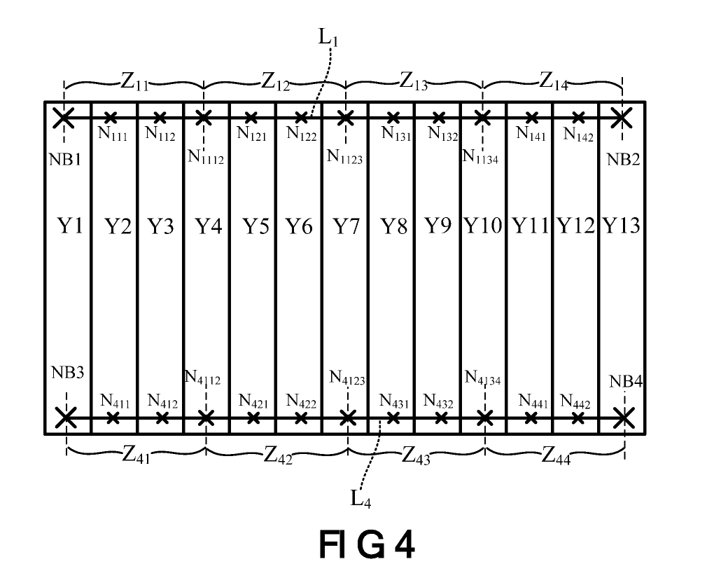

Please referring to FIGS. 2, 3 and 4, FIG. 3 is a schematic diagram of an embodiment of the image correcting process of the touch panel correcting apparatus according to the present invention. FIG. 4 is a schematic diagram of an embodiment of the plurality of detecting sections of the touch panel correcting apparatus according to the present invention. As shown in FIGS. 2 to 4, the first predetermined manner executes actions to set at least two basic points NB1˜NB4 on the touch panel 21 and to execute the pointing action according to a predetermined pattern between the at least two basic points NB1˜NB4. Wherein, the predetermined pattern is one of the straight lines L1˜L4 between those two basic points NB1˜NB4 respectively in one embodiment. The second predetermined manner executes action to set a plurality of detecting sections Z11˜Z14 according to the at least two basic points NB1˜NB4, each one of the detecting sections Z11˜Z14 has a plurality of detecting points N₁₁₁, N₁₁₂, N₁₂, N₁₂₁, N₁₂₂, N₂₃, N₁₃₁, N₁₃₂, N₃₄, N₁₄₁, N₁₄₂, the detecting module 26 is used for detecting the plurality of detecting points N₁₁₁, N₁₁₂, N₁₂, N₁₂₁, N₁₂₂, N₂₃, N₁₃₁, N₁₃₂, N₃₄, N₁₄₁, N₁₄₂ and further generating the at least one detecting result R_{DE}.

In one embodiment, the touch panel 21 includes a plurality of detecting zones (only shown Y1˜Y13 in FIG. 4), each one of the detecting zones (Y1˜Y13) is corresponding to the two of those detecting points (N111, N112, N1112, N121, N122, N1123, N131, N132, N1134, N141, N142 and N411, N412, N4112, N421, N422, N4123, N431, N432, N4134, N441, N442). In one embodiment, the plurality of detecting zones (only shown Y1˜Y13 in FIG. 4) are a plurality of detecting zones (AS shown as those detecting zones X1˜X8 and Y1˜Y8) of the resistive touch panel. The detecting module 26 generates the at least one detecting result R_{D E} according to the at least two detecting points (N111, N112, N1112, N121, N122, N1123, N131, N132, N1134, N141, N142 and N411, N412, N4112, N421, N422, N4123, N431, N432, N4134, N441, N442), and the judging module 28 executes a interpolation operation according to the predetermined information and the at least one detecting result R_{DE} to generate the at least one correcting value V_{DT}.

The predetermined information is a size of the screen of the touch panel 21 presetting in the judging module 28. In one embodiment, the predetermined information is an expected image size of the displayed image on the touch panel 21, the touch panel correcting apparatus 20 determines which expected image size and correcting the displayed image on the touch panel 21 accordingly.

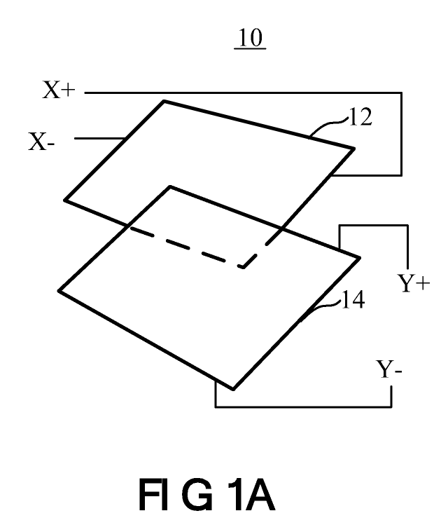

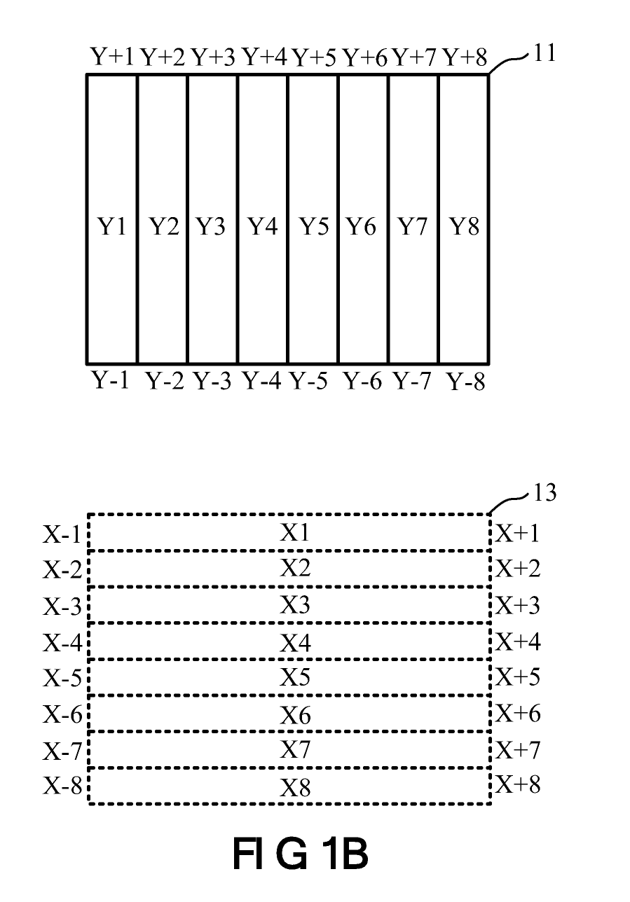

The following descriptions are used for interpreting the correcting manner of the touch panel correcting apparatus 20 for correcting the touch panel 21. At first, the control module 22 generates the controlling signal S_{C}, the processing module 24 executes the pointing action for pointing out at least two basic points (NB1˜NB4) and further drafting a straight line between those pointed out at least two basic points (NB1˜NB4). The detecting module 26 determines a plurality of detecting sections (Z11˜Z14, Z41˜Z44), wherein each one of the detecting sections (Z11˜Z14, Z41˜Z44) includes a plurality of detecting points (N111, N112, N121, N121, N122, N1123, N131, N132, N1134, N141, N142). In one embodiment, each one of the plurality of detecting points (N111, N112, N1112, N121, N122, N1123, N131, N132, N1134, N141, N142 and N411, N412, N4112, N421, N422, N4123, N431, N432, N4134, N441, N442) is corresponding to each one of the detecting zones of the resistive touch panel as shown as the detecting zones X1˜X8 in FIG. 1B. The detecting module 26 detects the plurality of detecting points (N111, N112, N1112, N121, N122, N1123, N131, N132, N1134, N141, N142 and N411, N412, N4112, N421, N422, N4123, N431, N432, N4134, N441, N442) and then generates at least one detecting result R_{DE} correspondingly. The judging module 28 executes a interpolation operation with the at least two detecting points (N111, N112, N1112, N121, N122, N1123, N131, N132, N1134, N141, N142 and N411, N412, N4112, N421, N422, N4123, N431, N432, N4134, N441, N442) of each detecting zone (Y1˜Y13) respectively according to the at least one detecting result R_{DE} and a predetermined expected image size of the displayed image on the touch panel 21, and then generates correcting values V_{DT} of each detecting section (Z11˜Z14, Z41˜Z44). Furthermore, the correcting module 30 corrects all of the detecting sections (Z11˜Z14, Z41˜Z44) of the pouch panel 21 according to the correcting values V_{DT} to complete the correcting action of the touch panel 21.

Wherein, the number of the plurality of detecting sections (Z11˜Z14, Z41˜Z44) and the detecting points (N111, N112, N1112, N121, N122, N1123, N131, N132, N1134, N141, N142 and N411, N412, N4112, N421, N422, N4123, N431, N432, N4134, N441, N442) are decided by the user according to the actually condition of different embodiments but not limited by this embodiment. With the number of those detecting points (N111, N112, N1112, N121, N122, N1123, N131, N132, N1134, N141, N142 and N411, N412, N4112, N421, N422, N4123, N431, N432, N4134, N441, N442) getting more and more, the correcting efficiency of the touch panel correcting apparatus 20 is more accurate. Correcting four straight lines L1˜L4 of the touch panel 21 according to the correcting manner of the above description, the touch panel correcting apparatus 20 can complete the image correcting action of the touch panel 21.

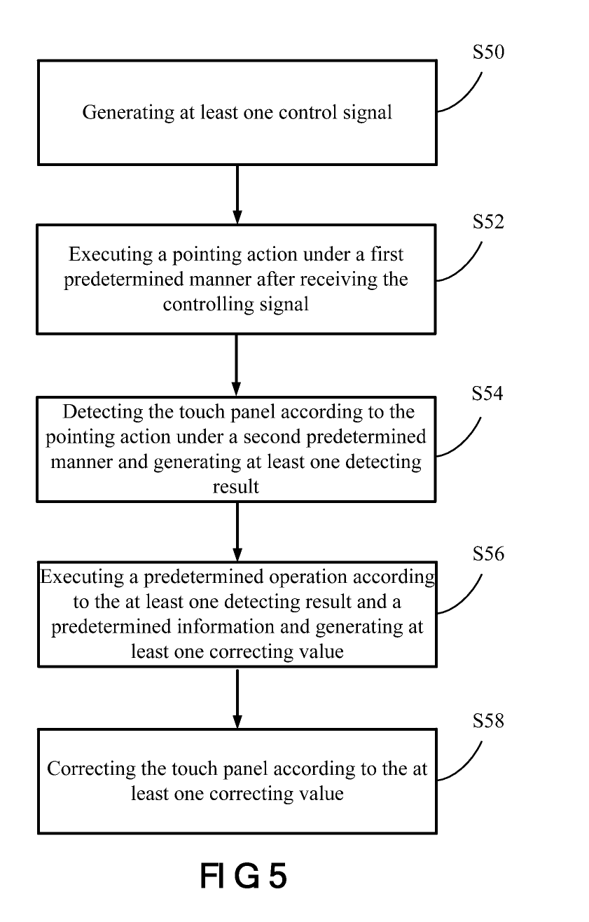

Please referring to the FIG. 5, FIG. 5 is a flowchart diagram of an embodiment of the touch panel correcting method according to the present invention. As shown in the FIG. 5, the present invention is a touch panel correcting method for correcting original image displayed by a touch panel, which comprising the following steps:

Step 50: Generating at least one control signal;
Step 52: Executing a pointing action under a first predetermined manner after receiving the controlling signal;
Step 54: Detecting the touch panel according to the pointing action under a second predetermined manner and generating at least one detecting result;
Step 56: Executing a predetermined operation according to the at least one detecting result and predetermined information and generating at least one correcting value; and
Step 58: Correcting the touch panel according to the at least one correcting value.

In one embodiment, the first predetermined manner executes the actions to set at least two basic points on the touch panel and to execute the pointing action according to a predetermined pattern between the at least two basic points. The predetermined pattern is a straight line between at least two basic points. The second predetermined manner executes action to set a plurality of detecting sections according to the at least two basic points, each detecting section has a plurality of detecting points. The step S54 of the touch panel correcting method detects the plurality of detecting points and generates the at least one detecting result. Wherein The touch panel includes a plurality of detecting zones, each one of the detecting zones is corresponding to two of those at least two detecting points, the step S54 of the touch panel correcting method generates the at least one detecting result according to the at least two detecting points, and then the step S56 of the touch panel correcting method executes a interpolation operation according to the predetermined information and the at least one detecting result to generate the at least one correcting value. The predetermined information is a size of the screen of the touch panel presetting in the judging module.

As mentioned above, the present invention provides a touch panel correcting apparatus and method for selecting at least two basic points and drafting the straight line between the at least two basic points. User can decide the number of the detecting points for correcting the displayed image according to the actually condition in different embodiments respectively. Because of the straight line is composed of a plurality of detecting points, therefore the correcting manner of the touch panel correcting apparatus and the method of this invention can reach the optimizing efficiency of correcting the displayed image of the screen of touch panel. Compared with the prior art, no matter pointing out every one of the detecting points by human or machine wastes a lot of times so that cannot enhance the efficiency of image correcting. Accordingly the descriptions above, the touch panel correcting apparatus and the method of this invention not only optimizes the efficiency of image correcting but also reduces the time for correcting the image, further enhance the efficiency for correcting the image of the touch panel.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A touch panel correcting apparatus, comprising:
a control module for generating a controlling signal;
a processing module coupled to the control module and a touch panel for executing a pointing action under a first predetermined manner after receiving the controlling signal;
a detecting module coupled to the control module, the processing module and the touch panel for detecting the touch panel according to the pointing action under a second predetermined manner and generating at least one detecting result;
a judging module coupled to the processing module and the detecting module for executing a predetermined operation according to the at least one detecting result and a predetermined information and generating at least one correcting value; and
a correcting module coupled to the judging module and the touch panel for correcting the touch panel according to the at least one correcting value.

2. The touch panel correcting apparatus of claim 1, wherein the first predetermined manner executes actions to set at least two basic points on the touch panel and to execute the pointing action according to a predetermined pattern between the at least two basic points.

3. The touch panel correcting apparatus of claim 2, wherein the predetermined pattern is a straight line.

4. The touch panel correcting apparatus of claim 1, wherein the second predetermined manner executes action to set a plurality of detecting sections according to the at least two basic points, each detecting section has a plurality of detecting points, the detecting module is used for detecting the plurality of detecting points and generating the at least one detecting result.

5. The touch panel correcting apparatus of claim 4, wherein the touch panel includes a plurality of detecting zones, each one of the plurality of detecting zones is corresponding to the at least two detecting points, the detecting module generates the at least one detecting result according to the at least two detecting points, and the judging module executing a interpolation operation according to the predetermined information and the at least one detecting result to generate the at least one correcting value.

6. The touch panel correcting apparatus of claim 5, wherein the predetermined information is a size of the screen of the touch panel presetting in the judging module.

7. A touch panel correcting method comprising the following step:
(a) generating at least one controlling signal;
(b) executing a pointing action under a first predetermined manner after receiving the controlling signal;
(c) detecting the touch panel according to the pointing action under a second predetermined manner and generating at least one detecting result;
(d) executing a predetermined operation according to the at least one detecting result and a predetermined information and generating at least one correcting value; and
(e) correcting the touch panel according to the at least one correcting value.

8. The touch panel correcting method of claim 7, wherein the first predetermined manner executes actions to set at least two basic points on the touch panel and executing the pointing action according to a predetermined pattern between the at least two basic points.

9. The touch panel correcting method of claim 8, wherein the predetermined pattern is a straight line.

10. The touch panel correcting method of claim 7, wherein the second predetermined manner executes to set a plurality of detecting sections according to the at least two basic points, each one of the detecting section includes a plurality of detecting points, the step (c) is used for detecting the plurality of detecting points and generating the at least one detecting result.

11. The touch panel correcting method of claim 7, wherein the touch panel includes a plurality of detecting zones, each one of the plurality of detecting zones is corresponding to the at least two detecting points, the step (c) generates the at least one detecting result according to the at least two detecting points, and the step (d) executing a interpolation operation according to the predetermined information and the at least one detecting result to generate the at least one correcting value.

12. The touch panel correcting method of claim 7, wherein the predetermined information is a size of the screen of the touch panel presetting in the judging module.
